(19) United States
(12) Patent Application Publication
(10) Pub. No.: US 2021/0387122 A1
(43) Pub. Date: Dec. 16, 2021

(54) CATALYST-ADSORBENT FILTER FOR AIR PURIFICATION

(71) Applicant: BASF Corporation, Florham Park, NJ (US)

(72) Inventors: Ting GU, Shanghai (CN); Chen CHEN, Shanghai (CN)

(21) Appl. No.: 17/287,779

(22) PCT Filed: Oct. 22, 2019
(86) PCT No.: PCT/US19/57348

§ 371 Date: Apr. 22, 2021

(30) Foreign Application Priority Data
Oct. 23, 2018 (CN) PCT/CN2018/011142

(51) Int. Cl. B01D 39/16; B01D 53/04; B01D 53/86; B01J 20/28; B01J 20/26; B01J 20/20; B01J 20/32; B01J 23/32; B01J 37/00; B01J 37/03; B01J 37/08; B01J 35/00; B01J 35/04

(52) U.S. Cl. CPC B01D 39/1676; B01D 2253/3425; B01D 53/8609; B01D 53/8628; B01D 53/8634; B01J 20/28045; B01J 20/28059; B01J 20/28061; B01J 20/28064; B01J 20/28066; B01J 20/261; B01J 20/262; B01J 20/20; B01J 20/3212; B01J 20/3223; B01J 20/324; B01J 23/32; B01J 37/0009; B01J 37/038; B01J 37/08; B01J 35/0006; B01J 35/04; B01D 2239/0407; B01D 2239/0478; B01D 2253/102; B01D 2257/302; B01D 2257/404; B01D 2257/406; B01D 2255/2073; B01D 2255/9155; B01D 2255/9207; B01D 2253/306; B01D 53/0415

(57) ABSTRACT

Disclosed in certain embodiments are catalyst-adsorbent compositions that include a metal oxide catalyst adapted for converting gaseous pollutants into chemically-benign species, and an adsorbent adapted for adsorbing the chemically-benign species together with other gaseous species and volatile organic compounds.

### CROSS-REFERENCE TO RELATED APPLICATIONS

This application claims the benefit of priority of International Application No. PCT/CN2018/111425, filed Oct. 23, 2018, the disclosure of which is hereby incorporated by reference herein in its entirety.

### TECHNICAL FIELD

The present disclosure relates to compositions, devices, and methods for air purification. More particularly, the disclosure relates to catalyst-adsorbent compositions, devices, and systems, methods of their preparation, and methods of their use for room temperature removal of gaseous pollutants from air.

### BACKGROUND

Atmospheric pollution is a concern of increasing importance as the levels of various atmospheric pollutants continue to increase. Formaldehyde, nitrogen oxides, sulfur dioxide, and ammonia are regarded as major pollutants for which various sorbent systems and materials are used to remove them from indoor environments.

Traditional pollutant treatment systems and sorbent materials still face many challenges, including improving long term performance, increasing the efficiency of manufacturing operations, and reducing production costs. Many sorbent materials are generally adapted for one type of adsorption application, while being unable to remove other types of pollutants. Current cathode air purification technology, for example, requires two separate layers for the removal of basic and acidic chemical contaminants, thus requiring more complex design. In addition, nonwoven filter systems that utilize carbon pellets result in high backpressure that has a detrimental effect on performance.

Thus, there continues to be a need for devices, methods, and compositions that can effectively remove multiple pollutants simultaneously.

### SUMMARY OF THE DISCLOSURE

The following presents a simplified summary of various aspects of the present disclosure in order to provide a basic understanding of such aspects. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In one aspect of the present disclosure, a catalyst-adsorbent filter comprises: a filter body comprising a material selected from polymeric foam, polymeric fiber, non-woven fabric, a ceramic, and pulp products (e.g., paper); and a coating formed on the filter body. The coating comprises: a manganese oxide catalyst adapted for converting gaseous pollutants into chemically-benign species; and an adsorbent adapted for adsorbing the chemically-benign species and other gaseous species for which the manganese oxide catalyst is not adapted to convert.

In certain embodiments, the adsorbent is selected from a group consisting of: silica gel, activated carbon, faujasite, chabazite, clinoptilolite, mordenite, silicalite, zeolite X, zeolite Y, ultrastable zeolite Y, ZSM zeolite, offretite, beta zeolite, metal organic frameworks, metal oxide, polymers, resins, and combinations thereof.

In certain embodiments, the adsorbent comprises activated carbon.

In certain embodiments, the activated carbon is synthetic activated carbon or is based on or derived from one or more of wood, peat coal, coconut shell, lignite, petroleum pitch, petroleum coke, coal tar pitch, fruit pits, nuts, shells, sawdust, wood flour, synthetic polymer, or natural polymer.

In certain embodiments, a Brunauer-Emmett-Teller (BET) surface area of the adsorbent is from about 20 m²/g to about 3,000 m²/g.

In certain embodiments, a weight-to-weight ratio of the manganese oxide to the adsorbent is from 1:5 to 7:1.

In certain embodiments, the coating further comprises a polymeric binder, and the polymeric binder is selected from a group consisting of: polyethylene, polypropylene, polyolefin copolymer, polyisoprene, polybutadiene, polybutadiene copolymer, chlorinated rubber, nitrile rubber, polychloroprene, ethylene-propylene-diene elastomer, polystyrene, polyacrylate, polymethacrylate, polyacrylonitrile, poly(vinyl ester), poly(vinyl halide), polyamide, cellulosic polymer, polyimide, acrylic polymer, vinyl acrylic polymer, styrene acrylic polymer, polyvinyl alcohol, thermoplastic polyester, thermosetting polyester, poly(phenylene oxide), poly(phenylene sulfide), fluorinated polymer, poly(tetrafluoroethylene) polyvinylidene fluoride, poly(vinylfluoride) chloro/fluoro copolymer, ethylene chlorotrifluoroethylene copolymer, polyamide, phenolic resin, epoxy resin, polyurethane, acrylic/styrene acrylic copolymer, latex, silicone polymer, and combinations thereof.

In certain embodiments, the polymeric binder is present from about 5 wt. % to about 30 wt. % with respect to a total weight of the coating.

In certain embodiments, the coating further comprises a dispersant. In certain embodiments, the dispersant comprises one or more of an anionic surfactant, a cationic surfactant, a zwitterionic surfactant, or a nonionic surfactant.

In certain embodiments, the filter body comprises a polymeric foam comprising polyurethane.

In certain embodiments, the filter body is in a form of a honeycomb.

In another aspect of the present disclosure, a catalyst-adsorbent composition comprises: an adsorbent comprising activated carbon; a catalyst comprising manganese oxide; a polymeric binder; and a surfactant dispersant.

In another aspect of the present disclosure, a method of forming a catalyst-adsorbent filter comprises: forming a slurry comprising a metal oxide catalyst and an adsorbent; coating the slurry onto a filter body comprising a material selected from polymeric foam, polymeric fiber, non-woven fabric, a ceramic, and pulp products (e.g., paper); and drying the slurry to form the catalyst-adsorbent filter.

In certain embodiments, the drying occurs at a temperature from about 80° C. to about 250° C.

In certain embodiments, the adsorbent comprises activated carbon, and a BET surface area of the adsorbent is from about 20 m²/g to about 3,000 m²/g.

In certain embodiments the metal oxide catalyst comprises manganese oxide, a weight-to-weight ratio of the manganese oxide to the adsorbent is from 1:5 to 7:1.

In certain embodiments the slurry further comprises a polymeric binder. In certain embodiments the polymeric binder is present from about 5 wt. % to about 30 wt. % with respect to a total weight of the coating. In certain embodiments, the polymeric binder is selected from a group consisting of: polyethylene, polypropylene, polyolefin copolymer, polyisoprene, polybutadiene, polybutadiene copolymer, chlorinated rubber, nitrile rubber, polychloroprene, ethylene-propylene-diene elastomer, polystyrene, polyacrylate, polymethacrylate, polyacrylonitrile, poly(vinyl ester), poly(vinyl halide), polyamide, cellulosic polymer, polyimide, acrylic polymer, vinyl acrylic polymer, styrene acrylic polymer, polyvinyl alcohol, thermoplastic polyester, thermosetting polyester, poly(phenylene oxide), poly(phenylene sulfide), fluorinated polymer, poly(tetrafluoroethylene) polyvinylidene fluoride, poly(vinylfluoride) chloro/fluoro copolymer, ethylene chlorotrifluoroethylene copolymer, polyamide, phenolic resin, epoxy resin, polyurethane, acrylic/styrene acrylic copolymer, latex, silicone polymer, and combinations thereof.

In certain embodiments the slurry further comprises a dispersant, and the dispersant comprises one or more of an anionic surfactant, a cationic surfactant, a zwitterionic surfactant, or a nonionic surfactant.

In certain embodiments, the filter body comprises a polymeric foam comprising polyurethane.

In another aspect of the present disclosure, a catalyst-adsorbent filter comprises: a filter body comprising a material selected from polymeric foam, polymeric fiber, non-woven fabric, a ceramic, and pulp products (e.g., paper); and a coating formed on the filter body. The coating comprising: a manganese oxide catalyst adapted for converting gaseous pollutants into chemically-benign species; an adsorbent adapted for adsorbing the chemically-benign species together with other gaseous species and volatile organic compounds; a polymeric binder; and a dispersant.

In another aspect of the present disclosure, a volatile organic compound (VOC) scrubbing system comprises any embodiments of the aforementioned catalyst-adsorbent arranged to contact air received into the VOC scrubbing system. In one embodiment, the VOC scrubbing system comprises one or more filtration cartridges having the catalyst-adsorbent disposed therein and arranged to contact a flow of air received into the VOC scrubbing system.

Any embodiments of the aforementioned catalyst-adsorbent may be disposed within the one or more filtration cartridges.

In another aspect of the present disclosure, a method for treating air comprising a pollutant selected from SO₂, NH₃, NO₂, NO, and formaldehyde, the method comprising flowing a first volume of air into an air treatment chamber that comprises any embodiments of the aforementioned catalyst-adsorbent, the first volume of air having a first concentration of the pollutant, and contacting the sorbent with the first volume of air, wherein a second concentration of the pollutant of the first volume of air is less than or equal to the first concentration after the contacting. In certain embodiments, the first volume of air comprises recirculated air from an interior of a building. In certain embodiments, the method further comprises flowing a second volume of air into the air treatment chamber, the second volume of air having a third concentration of the pollutant, and contacting the sorbent with the second volume of air, wherein a fourth concentration of the pollutant of the second volume of air is greater than or equal to the third concentration after the contacting. In certain embodiments, the second volume of air comprises air from outside of the building.

In another aspect of the present disclosure, an automobile ventilation system comprises a component (e.g., a filter, filter unit, container, air duct, etc.) that comprises any embodiments of the aforementioned catalyst-adsorbent disposed within the component.

In another aspect of the present disclosure, an aircraft environmental control system comprises a filter unit that comprises any embodiments of the aforementioned catalyst-adsorbent disposed within the filter unit.

In another aspect of the present disclosure, a cathode air filter for a fuel cell system comprises a filter unit that comprises any embodiments of the aforementioned catalyst-adsorbent disposed within the filter unit. Such cathode air filters system may be incorporated into, for example, fuel cell systems for vehicles, homes, or industrial use.

In another aspect of the present disclosure, an air control system for removing a pollutant from atmospheric air comprises a filter unit that comprises any embodiments of the aforementioned sorbent disposed within the filter unit.

As used herein, the term “adsorbent material” refers to a material that can adhere gas molecules, ions, or other species within its structure (e.g., removal of CO₂ from air). Specific materials include but are not limited to clays, metal organic framework, activated alumina, silica gel, activated carbon, molecular sieve carbon, zeolites (e.g., molecular sieve zeolites), polymers, resins, and any of these components or others having a gas-adsorbing material supported thereon (e.g., such as the various embodiments of sorbents described herein). Certain adsorbent materials may preferentially or selectively adhere particular species.

Also as used herein, the term “catalyst-adsorbent” refers to a material that has dual catalytic and adsorptive properties. For example, a catalyst-adsorbent layer, upon contact with a molecular species, may catalyze the conversion of the molecular species into one or more byproducts, and may also be capable of adsorbing the molecular species and/or the one or more byproducts. The catalyst-adsorbent layer may also be capable of adsorbing other molecular species that cannot be reacted catalytically by the catalyst-adsorbent layer.

As used herein, the term “adsorption capacity” refers to a working capacity for an amount of a chemical species that an adsorbent material can adsorb under specific operating conditions (e.g., temperature and pressure). The units of adsorption capacity, when given in units of mg/g, correspond to milligrams of adsorbed gas per gram of sorbent.

Also as used herein, the term “particles” refers to a collection of discrete portions of a material each having a largest dimension ranging from 0.1 μm to 50 mm. The morphology of particles may be crystalline, semi-crystalline, or amorphous. The size ranges disclosed herein can be mean/average or median size, unless otherwise stated. It is noted also that particles need not be spherical, but may be in a form of cubes, cylinders, discs, or any other suitable shape as would be appreciated by one of ordinary skill in the art. “Powders” and “granules” may be types of particles.

Also as used herein, the term “monolith” refers to a single unitary block of a particular material. The single unitary block can be in the form of, e.g., a brick, a disk, or a rod and can contain channels for increased gas flow/distribution. In certain embodiments, multiple monoliths can be arranged together to form a desired shape. In certain embodiments, a monolith may have a honeycomb shape with multiple parallel channels each having a square shape, a hexagonal shape, or another other shape.

Also as used herein, the term “dispersant” refers to a compound that helps to maintain solid particles in a state of suspension in a fluid medium, and inhibits or reduces agglomeration or settling of the particles in the fluid medium.

Also as used herein, the term “binder” refers to a material that, when included in a coating, layer, or film (e.g., a washcoated coating, layer, or film on a substrate), promotes the formation of a continuous or substantially continuous structure from one outer surface of the coating, layer, or film through to the opposite outer surface, is homogeneously or semi-homogeneously distributed in the coating, layer, or film, and promotes adhesion to a surface on which the coating, layer, or film is formed and cohesion between the surface and the coating, layer, or film.

Also as used herein, the terms “stream” or “flow” broadly refer to any flowing gas that may contain solids (e.g., particulates), liquids (e.g., vapor), and/or gaseous mixtures.

Also as used herein, the terms “volatile organic compounds” or “VOCs” refer to organic chemical molecules having an elevated vapor pressure at room temperature. Such chemical molecules have a low boiling point and a large number of the molecules evaporate and/or sublime at room temperature, thereby transitioning from a liquid or solid phase to a gas phase. Common VOCs include, but are not limited to, formaldehyde, benzene, toluene, xylene, ethylbenzene, styrene, propane, hexane, cyclohexane, limonene, pinene, acetaldehyde, hexaldehyde, ethyl acetate, butanol, and the like.

Also as used herein, the terms “unpurified air” or “unpurified air stream” refer to any stream that contains one or more pollutants at a concentration or content at or above a level that is perceived as nuisance, is considered to have adverse effects on human health (including short term and/or long term effects), and/or causes adverse effects in the operation of equipment. For example, in certain embodiments, a stream that contains formaldehyde at a concentration greater than 0.5 part formaldehyde per million parts of air stream calculated as an eight hour time weighted average concentration pursuant to “action level” standards set forth by the Occupational Safety & Health Administration is an unpurified air stream. In certain embodiments, a stream that contains formaldehyde at a concentration greater than 0.08 part formaldehyde per million parts of air stream calculated as an eight hour time weighted average concentration pursuant to national standards in China is an unpurified air stream. Unpurified air may include, but is not limited to, formaldehyde, ozone, carbon monoxide (CO), VOCs, methyl bromide, water, amine-containing compounds (e.g., ammonia), sulfur oxides, hydrogen sulfide, and nitrogen oxides.

Also as used herein, the terms “purified air” or “purified air stream” refer to any stream that contains one or more pollutants at a concentration or content that is lower than the concentration or content of the one or more pollutants in what would be considered an unpurified air stream.

Also as used herein, the term “substrate” refers to a material (e.g., a metal, semi-metal, semi-metal oxide, metal oxide, polymeric, ceramic, paper, pulp/semi-pulp products, etc.) onto or into which the catalyst is placed. In certain embodiments, the substrate may be in the form of a solid surface having a washcoat containing a plurality of catalytic particles and/or adsorbent particles. A washcoat may be formed by preparing a slurry containing a specified solids content (e.g., 30-50% by weight) of catalytic particles and/or adsorbent particles, which is then coated onto a substrate and dried to provide a washcoat layer. In certain embodiments, the substrate may be porous and the washcoat may be deposited outside and/or inside the pores.

Also as used herein, the term “nitrogen oxide” refers to compounds containing nitrogen and oxygen including but not limited to, nitric oxide, nitrogen dioxide, nitrous oxide, nitrosylazide, ozatetrazole, dinitrogen trioxide, dinitrogen tetroxide, dinitrogen pentoxide, trinitramide, nitrite, nitrate, nitronium, nitrosonium, peroxonitrite, or combinations thereof.

Also as used herein, the term “sulfur compounds” refers to compounds containing sulfur including but not limited to sulfur oxides (sulfur monoxide, sulfur dioxide, sulfur trioxide, disulfur monoxide, disulfur dioxide), hydrogen sulfide, or combinations thereof.

Also as used herein, the term “about,” as used in connection with a measured quantity, refers to the normal variations in that measured quantity, as expected by the skilled artisan making the measurement and exercising a level of care commensurate with the objective of measurement and the precision of the measuring equipment. For example, when “about” modifies a value, it may be interpreted to mean that the value can vary by f1%.

Surface area, as discussed herein, is determined by the Brunauer-Emmett-Teller (BET) method according to DIN ISO 9277:2003-05 (which is a revised version of DIN 66131), which is referred to as “BET surface area.” The specific surface area is determined by a multipoint BET measurement in the relative pressure range from 0.05-0.3 p/p₀.

### BRIEF DESCRIPTION OF THE DRAWINGS

The present disclosure is illustrated by way of example, and not by way of limitation, in the figures of the accompanying drawings, in which:

FIG. 1 depicts an illustrative air-flow system in accordance with an embodiment of the disclosure;

FIG. 2A depicts a cross-section of a filter body having a catalyst-adsorbent coating formed thereon in accordance with an embodiment of the disclosure;

FIG. 2B depicts a cross-section of a catalyst-adsorbent coating formed on a surface of a filter body in accordance with an embodiment of the disclosure; and

FIG. 3 is a flow diagram illustrating a method of forming a catalyst-adsorbent filter sorbent in accordance with an embodiment of the disclosure.

### DETAILED DESCRIPTION

The embodiments described herein relate to catalyst-adsorbent compositions and systems for removing pollutants from air. More specifically, the catalyst-adsorbent compositions may be incorporated into indoor air, cabin air, and cathode air purification systems, which may be designed to remove toxic chemical pollutants such as formaldehyde, ozone, carbon monoxide, nitrogen oxides, sulfur dioxide, amines (including ammonia), sulfur compounds (including thiols), chlorinated hydrocarbons, and other alkali or acidic chemicals.

In certain embodiments, a high surface area adsorbent (e.g., activated carbon) mixed with a metal oxide catalyst (e.g., manganese oxide) and other functional additives yields a catalyst-adsorbent composition that serves as an all-in-one solution for removing gaseous pollutions described herein with high efficiency. The catalyst-adsorbent composition may be coated onto a filter body, such as an open-pored foam, honeycomb, or nonwoven filter body, to increase filtration efficiency and facilitate acceptable backpressure.

The embodiments of the present disclosure allow for air purification at low temperatures (e.g., room temperature ranges from 20° C. to 25° C.) without requiring heating of the unpurified air or catalyst-adsorbent filter. In addition, the materials and relatively low temperatures utilized in forming the catalyst-adsorbent composition allow for a broader range of filters, such as polymeric foam materials, that would otherwise be incompatible with higher temperature processes used for coating metallic filters.

The embodiments of the present disclosure further allow for effective catalysis without the use of ultra-violet (UV) radiation or electricity, and are free of photo-catalytic chemistry.

The embodiments of the present disclosure further allow for the formation of catalyst-adsorbent filters that are free of detectable odors even after long term operation.

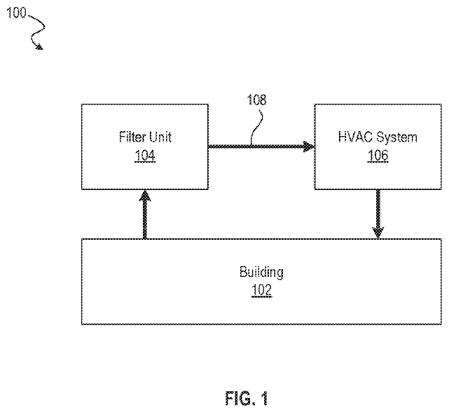

FIG. 1 depicts an illustrative air-flow system 100 in accordance with an embodiment of the disclosure. The system 100 includes a filter unit 104 and an HVAC system 106 installed as part of a building 102. As shown in FIG. 1, the filter scrubber unit 104 and the HVAC system 106 are fluidly coupled to each other and to the interior air space of the building 102 such that a recirculation air flow path 108 is established. As various pollutants, such as VOCs, accumulate within the interior air space of the building 102, interior air is recirculated through the filter unit 104 to catalyze and/or adsorb the pollutants using a catalyst-adsorbent filter, as described herein. Purified air then passes through the HVAC system 106, which may be further filtered (e.g., to remove dust and other particulates) and may be heated or cooled before being recirculated back into the building 102.

The embodiment of system 100 is merely illustrative, and it is to be understood that the embodiments of catalyst-adsorbent filters described herein may be incorporated into other systems for treating air, such as an automobile ventilation system, and aircraft environmental control system, an air control system for treating atmospheric air, humidifying/dehumidifying systems, odor removal systems, VOC scrubbing systems, treatment systems for cathode air in fuel cell systems for cars, homes, or industrial use, and other systems.

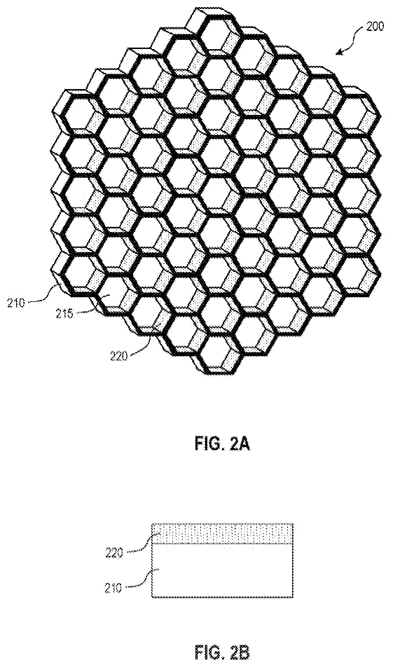

FIGS. 2A and 2B depict a cross-sections of a catalyst-adsorbent filter 200 formed in accordance with an embodiment of the disclosure. The catalyst-adsorbent filter 200 includes a filter body 210, which is illustrated as being in a form of a honeycomb filter with air passageways 215 formed therethrough. It is to be understood that the honeycomb filter is merely illustrative, and that other filter shapes may be used. The catalyst-adsorbent filter 200 further includes a catalyst-adsorbent composition coated onto interior walls of the filter body 200.

In certain embodiments, the filter body may be in the form of an open-pored foam, a honeycomb, or a nonwoven filter body. In certain embodiments, a material of the filter body may be ceramic (e.g., porous ceramic), metallic, polymeric foam, plastic, paper, fibrous (e.g., polymeric fiber), or combinations thereof. For example, in certain embodiments, the filter body may be formed from polyurethane fibers or a polyurethane foam. In certain embodiments, the filter body may be a metallic monolithic filter body, a ceramic monolithic filter body, a paper filter body, a polymer filter body, or a ceramic fiber monolithic substrate. In certain embodiments, the filter body may be an HVAC duct, an air filter, or a louver surface. In certain embodiments, the filter body may be a portable air filter, or a filter disposed in a vehicle, such as a motor vehicle, railed vehicle, watercraft, aircraft, or space craft.

In certain embodiments, the catalyst-adsorbent composition may be formulated as a slurry and washcoated onto the filter body. In certain embodiments, a loading of the catalyst-adsorbent composition on the filter body may range from about 0.5 g/in³ to about 4 g/in³ with respect to a volume of the filter body. In certain embodiments, the catalyst-adsorbent composition may be coated onto the filter body and may form a single catalyst-adsorbent layer on the solid substrate or a plurality of catalyst-adsorbent layers. If a plurality of catalyst-adsorbent layers is coated on the solid substrate, the layers may vary in their compositions or alternatively all catalyst-adsorbent layers may have the same composition.

In certain embodiments, the catalyst of the catalyst-adsorbent composition may comprise a catalytic metal oxide. The catalytic metal oxide may include one or more of manganese oxide, cobalt oxide, molybdenum oxide, chromium oxide, copper oxide, or cerium oxide. In certain embodiments, the metal oxide may be a rare earth metal oxide.

In certain embodiments, the catalytic metal oxide is manganese oxide. In certain embodiments, the manganese oxide is amorphous or at least partially amorphous. In certain embodiments, the manganese oxide is semi-crystalline. In certain embodiments, the manganese oxide may comprise cryptomelane, birnessite, vernadite, manganese oxide polymorph I, poorly crystalline cryptomelane, amorphous manganese oxide, polymorphs thereof, amorphous manganese oxide, or mixtures thereof.

In certain embodiments, the metal oxide catalyst is present from about 10 wt. % to about 90 wt. %, from about 20 wt. % to about 90 wt. %, from about 30 wt. % to about 90 wt. %, from about 30 wt. % to about 80 wt. %, from about 40 wt. % to about 80 wt. %, or from about 40 wt. % to about 70 wt. % based on a total weight of the catalyst-adsorbent composition.

In certain embodiments, the adsorbent of the catalyst-adsorbent composition comprises an adsorbent selected from silica gel, activated carbon, faujasite, chabazite, clinoptilolite, mordenite, silicalite, zeolite X, zeolite Y, ultrastable zeolite Y, ZSM zeolite (e.g., ZSM-5, ZSM-11), offretite, beta zeolite, metal organic frameworks, metal oxide, polymers, resins, and combinations thereof.

In certain embodiments, the adsorbent may include an adsorbent material may include a primary adsorbent (such as one or more discussed above) on a supporting material, such as carbon, an oxide (e.g., alumina, silica), or zeolite.

In certain embodiments, the adsorbent comprises activated carbon. The activated carbon may be synthetic activated carbon or based on or derived from wood, peat coal, coconut shell, lignite, petroleum pitch, petroleum coke, coal tar pitch, fruit pits, nuts, shells, sawdust, wood flour, synthetic polymer, natural polymer, and combinations thereof.

In certain embodiments, the adsorbent includes a plurality of porous particles in a powder form. In certain embodiments, an average size of the particles/powder ranges from about 1.0 μm to about 100 μm. In certain embodiments, the average size ranges from about 5.0 μm to about 50 μm. In certain embodiments, a BET surface area of the adsorbent is from about 20 m²/g to about 3,000 m²/g, or greater.

In certain embodiments, the BET surface area of the adsorbent is from about 50 m²/g to about 3,000 m²/g. In certain embodiments, the BET surface area of the adsorbent is from about 100 m²/g to about 3,000 m²/g. In certain embodiments, the BET surface area of the adsorbent is from about 250 m²/g to about 3,000 m²/g. In certain embodiments, the BET surface area of the adsorbent is from about 500 m²/g to about 3,000 m²/g. In certain embodiments, the BET surface area of the adsorbent is from about 600 m²/g to about 3,000 m²/g. In certain embodiments, the BET surface area of the adsorbent is from about 700 m²/g to about 3,000 m²/g. In certain embodiments, the BET surface area of the adsorbent is from about 800 m²/g to about 3,000 m²/g. In certain embodiments, the BET surface area of the adsorbent is from about 900 m²/g to about 3,000 m²/g. In certain embodiments, the BET surface area of the adsorbent is from about 1,000 m²/g to about 3,000 m²/g. In certain embodiments, the BET surface area of the adsorbent is from about 1,000 m²/g to about 2,750 m²/g. In certain embodiments, the BET surface area of the adsorbent is from about 1,000 m²/g to about 2,500 m²/g. In certain embodiments, the BET surface area of the adsorbent is from about 1,100 m²/g to about 2,500 m²/g. In certain embodiments, the BET surface area of the adsorbent is from about 1,200 m²/g to about 2,500 m²/g. In certain embodiments, the BET surface area of the adsorbent is from about 1,300 m²/g to about 2,500 m²/g. In certain embodiments, the BET surface area of the adsorbent is from about 1,400 m²/g to about 2,500 m²/g. In certain embodiments, the BET surface area of the adsorbent is from about 1,500 m²/g to about 2,500 m²/g. In certain embodiments, the BET surface area of the adsorbent is from about 1,600 m²/g to about 2,500 m²/g. In certain embodiments, the BET surface area of the adsorbent is from about 1,700 m²/g to about 2,500 m²/g. In certain embodiments, the BET surface area of the adsorbent is from about 1,800 m²/g to about 2,500 m²/g. In certain embodiments, the BET surface area of the adsorbent is from about 1,800 m²/g to about 2,400 m²/g. In certain embodiments, the BET surface area of the adsorbent is from about 1,800 m²/g to about 2,300 m²/g.

In certain embodiments, the adsorbent is activated carbon having a BET surface area from about 1,000 m²/g to about 2,500 m²/g. In certain embodiments, the adsorbent is activated carbon having a BET surface area from about 1,800 m²/g to about 2,300 m²/g.

In order to increase capacity of the porous support utilized in the embodiments of the present disclosure, the adsorbent can be activated. The activation may include subjecting the adsorbent (e.g., particles) to various conditions including, but not limited to, ambient temperature, vacuum, an inert gas flow, or any combination thereof, for a sufficient time to activate the adsorbent. In certain embodiments, the adsorbent may be activated by calcining.

In certain embodiments, a weight-to-weight ratio of the manganese oxide to the adsorbent is from 1:1 to 7:1. In certain embodiments, the weight-to-weight ratio is from 2:1 to 5:1. In certain embodiments, the weight-to-weight ratio may be 1:1, 2:1, 3:1, 4:1, 5:1, 6:1, 7:1, or any combination of subranges defined therebetween. In certain embodiments, the weight-to-weight ratio may be 1:1 to 1:5. In certain embodiments, the weight-to-weight ratio may be 1:1, 1:2, 1:3, 1:4, 1:5, or any combination of subranges defined therebetween.

In certain embodiments, the catalyst-adsorbent composition may further comprise a binder. Examples of suitable binders may include but are not limited to: polyethylene, polypropylene, polyolefin copolymers, polyisoprene, polybutadiene, polybutadiene copolymers, chlorinated rubber, nitrile rubber, polychloroprene, ethylene-propylene-diene elastomers, polystyrene, polyacrylate, polymethacrylate, polyacrylonitrile, poly(vinyl esters), poly (vinyl halides), polyamides, cellulosic polymers, polyimides, acrylics, vinyl acrylics, styrene acrylics, polyvinyl alcohols, thermoplastic polyesters, thermosetting polyesters, poly(phenylene oxide), poly(phenylene sulfide), fluorinated polymers such as poly(tetrafluoroethylene), polyvinylidene fluoride, poly(vinlyfluoride) and chloro/fluoro copolymers such as ethylene chlorotrifluoroethylene copolymer, polyamide, phenolic resins, polyurethane, acrylic/styrene acrylic copolymer latex and silicone polymers.

In certain embodiments, the binder is a polymeric binder selected from: polyethylene, polypropylene, polyolefin copolymer, polyisoprene, polybutadiene, polybutadiene copolymer, chlorinated rubber, nitrile rubber, polychloroprene, ethylene-propylene-diene elastomer, polystyrene, polyacrylate, polymethacrylate, polyacrylonitrile, poly(vinyl ester), poly(vinyl halide), polyamide, cellulosic polymer, polyimide, acrylic polymer, vinyl acrylic polymer, styrene acrylic polymer, polyvinyl alcohol, thermoplastic polyester, thermosetting polyester, poly(phenylene oxide), poly(phenylene sulfide), fluorinated polymer, poly(tetrafluoroethylene) polyvinylidene fluoride, poly(vinylfluoride) chloro/fluoro copolymer, ethylene chlorotrifluoroethylene copolymer, polyamide, phenolic resin, epoxy resin, polyurethane, acrylic/styrene acrylic copolymer, latex, silicone polymer, and combinations thereof. In certain embodiments, the binder comprises an acrylic/styrene copolymer latex and polyurethane dispersion.

In certain embodiments, the binder, or mixture of binders, is present from about 5 wt. % to about 30 wt. % with respect to a total weight of the catalyst-adsorbent composition when dried and deposited onto the filter body. In certain embodiments, the polymeric binder is present from about 10 wt. % to about 30 wt. %, from about 15 wt. % to about 30 wt. %, from about 5 wt. % to about 25 wt. %, from about 5 wt. % to about 20 wt. %, from about 10 wt. % to about 20 wt. %, or from about 15 wt. % to about 20 wt. %.

In certain embodiments, the catalyst-adsorbent composition includes a dispersant. The dispersant may include one or more of an anionic surfactant, a cationic surfactant, a zwitterionic surfactant, or a nonionic surfactant. In certain embodiments, the dispersant is a nonionic acrylic copolymer.

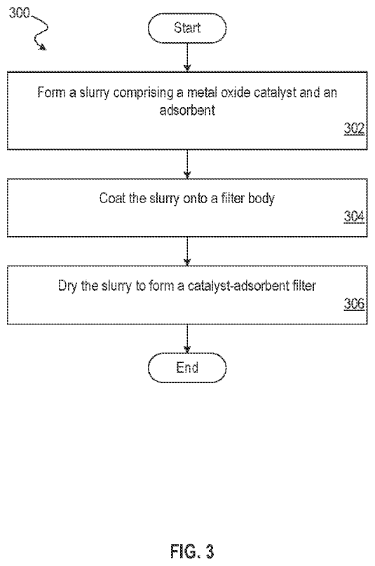

FIG. 3 is a flow diagram illustrating a method 300 of forming a catalyst-adsorbent filter sorbent in accordance with an embodiment of the disclosure. The method 300 begins at block 302, where a slurry is formed. The slurry comprises a metal oxide catalyst and an adsorbent, which may be formed by dissolving the metal oxide catalyst and adsorbent in an aqueous solution.

In certain embodiments, the slurry further comprises a polymeric binder. In certain embodiments, the polymeric binder is selected from: polyethylene, polypropylene, polyolefin copolymer, polyisoprene, polybutadiene, polybutadiene copolymer, chlorinated rubber, nitrile rubber, polychloroprene, ethylene-propylene-diene elastomer, polystyrene, polyacrylate, polymethacrylate, polyacrylonitrile, poly(vinyl ester), poly(vinyl halide), polyamide, cellulosic polymer, polyimide, acrylic polymer, vinyl acrylic polymer, styrene acrylic polymer, polyvinyl alcohol, thermoplastic polyester, thermosetting polyester, poly(phenylene oxide), poly(phenylene sulfide), fluorinated polymer, poly(tetrafluoroethylene) polyvinylidene fluoride, poly(vinylfluoride) chloro/fluoro copolymer, ethylene chlorotrifluoroethylene copolymer, polyamide, phenolic resin, epoxy resin, polyurethane, acrylic/styrene acrylic copolymer, latex, silicone polymer, and combinations thereof.

In certain embodiments, the slurry further comprises a dispersant. The dispersant may include one or more of an anionic surfactant, a cationic surfactant, a zwitterionic surfactant, or a nonionic surfactant.

In certain embodiments, the slurry further includes an oxidant, which may improve removal efficiency of nitrogen oxides. The oxidant may be selected from nitric acid, hypochlorite, a persulfate, a peroxide, permanganate, or a chlorate.

In certain embodiments, the slurry further includes an alkaline component, such as a hydroxide, ammonia, or a carbonate, which may improve slurry stabilization. In certain embodiments, a pH of the slurry may be adjusted between 2 and 12, or between 4 and 10.

At block 304, the slurry is coated onto a filter body. The filter body may comprise a material selected from polymeric foam, polymeric fiber, non-woven fabric, a ceramic, or a pulp product (e.g., paper). In certain embodiments, the filter body comprises a polymeric foam comprising polyurethane. In certain embodiments, the filter body is in a form of a honeycomb.

At block 306, the slurry is dried to form the catalyst-adsorbent filter. In certain embodiments, the drying is performed at a temperature from about 80° C. to about 250° C. The polymeric binder may be present from about 5 wt. % to about 30 wt. % with respect to a total weight of the coating.

It is noted that the blocks of method 300 are not limiting, and that, in certain embodiments, some or all of the blocks of their respective methods may be performed. In certain embodiments, one or more of the blocks may be performed substantially simultaneously. Some blocks may be omitted entirely or repeated.

### ILLUSTRATIVE EXAMPLES

The following examples are set forth to assist in understanding the disclosure and should not, of course, be construed as specifically limiting the embodiments described and claimed herein. Such variations of the embodiments, including the substitution of all equivalents now known or later developed, which would be within the purview of those skilled in the art, and changes in formulation or minor changes in experimental design, are to be considered to fall within the scope of the embodiments incorporated herein.

### Example 1

A mixture of 5.9 g of a dispersant, 27.4 g of potassium hydroxide (KOH), and 737 g water was prepared, and 297.6 g MnO₂ powder and 59.5 g activated carbon powder were then dispersed into the mixture to form a slurry having a 32 wt. % solid content based on a total weight of the slurry. A final slurry was achieved by adding to the slurry 31.2 g of a polyacrylic latex and 31.2 g polyurethane latex binder. The final slurry had a solids content of about 35 wt. %, a pH of about 10, and a maximum viscosity of 720 centipoise.

### Example 2

A test sample was prepared using a polyurethane foam core as a filter body. The polyurethane foam core had a diameter of 1 inch and a length of 40 millimeters. The polyurethane foam core was coated with the final slurry obtained from Example 1. The coated polyurethane foam core was dried at 110° C. and maintained at 110° C. for 1 hour. A washcoat dry gain of the coated polyurethane core was 1.8 g. An additional rectangular polyurethane foam sample having dimensions of 408 by 283 millimeters and a 5-millimeter thickness square polyurethane foam was coated by the same procedure, resulting in a washcoat dry gain of 49.3 g, which was tested using the GB/T 32085 standard.

### Comparative Example 1

A mixture of 13.2 g of a dispersant, 6.6 g of KOH, 99.3 g of polyacrylic latex, and 1127 g water was prepared, and 331 g of activated carbon powder was then dispersed into the mixture to form a slurry having a 26 wt. % solid content based on a total weight of the slurry, a pH of about 8, and a maximum viscosity of 1026 centipoise.

### Comparative Example 2

A test sample was prepared using a polyurethane foam core as a filter body. The polyurethane foam core had a diameter of 1 inch and a length of 40 millimeter. The polyurethane foam core was coated with the slurry obtained from Comparative Example 1. The coated polyurethane foam core was dried at 110° C. and maintained at 110° C. for 1 hour. A washcoat dry gain of the coated polyurethane core was 1.0 g.

### Results

Table 1 below summarizes the results obtained from placing the coated polyurethane foam cores into a plug-flow reactor. During the tests, the unpurified air stream included SO₂, NOx, and NH₃, each present at 30 ppm. Other parameters of the air stream include a temperature of 25±0.5° C., relative humidity of 18%, 10% O₂, and a space velocity of 150,000 h⁻¹, and a total flow time of 1 hour. Table 1 demonstrates that Example 2 is capable of adsorbing more pollutants than Comparative Example 2, with greater SO₂ adsorption capacity. Moreover, Example 2 exhibited improved washcoat adhesion than Comparative Example 2.

TABLE 1

| | SO₂ | NH₃ | NO₂ | NO | |
|---|---|---|---|---|---|
| | adsorption | adsorption | adsorption | adsorption | |
| | capacity | capacity | capacity | capacity | Washcoat |
| Sample | (mg/g) | (mg/g) | (mg/g) | (mg/g) | adhesion |
| Example 2 | 79.2 | 7.7 | 43.1 | 5.2 | Good |
| Comparative | 49.5 | 10.1 | 85.9 | No activity | Bad |
| Example 2 | | | | | |

In the foregoing description, numerous specific details are set forth, such as specific materials, dimensions, processes parameters, etc., to provide a thorough understanding of the embodiments of the present disclosure. The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the use of the terms “a,” “an,” “the,” and similar referents in the context of describing the materials and methods discussed herein (especially in the context of the following claims) are to be construed to cover both the singular and the plural, unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Reference throughout this specification to “one embodiment,” “certain embodiments,” “one or more embodiments,” “an embodiment,” or “some embodiments” means that a particular feature, structure, material, or characteristic described in connection with the embodiment is included in at least one embodiment of the present disclosure. Thus, the appearances of the phrases such as “in one or more embodiments,” “in certain embodiments,” “in one embodiment,” or “in an embodiment” in various places throughout this specification are not necessarily referring to the same embodiment of the present disclosure. Furthermore, the particular features, structures, materials, or characteristics may be combined in any suitable manner in one or more embodiments.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled. The use of any and all examples, or exemplary language (e.g., “such as”) provided herein, is intended merely to better illuminate the materials and methods and does not pose a limitation on the scope unless otherwise claimed. No language in the specification should be construed as indicating any non-claimed element as essential to the practice of the disclosed materials and methods.

Although the embodiments disclosed herein have been described with reference to particular embodiments it is to be understood that these embodiments are merely illustrative of the principles and applications of the present disclosure. It will be apparent to those skilled in the art that various modifications and variations can be made to the method and apparatus of the present disclosure without departing from the spirit and scope of the disclosure. Thus, it is intended that the present disclosure include modifications and variations that are within the scope of the appended claims and their equivalents, and the above-described embodiments are presented for purposes of illustration and not of limitation.

What is claimed is:

1. A catalyst-adsorbent filter, the catalyst-adsorbent filter comprising:
a filter body comprising a material selected from polymeric foam, polymeric fiber, non-woven fabric, a ceramic, and pulp products; and
a coating formed on the filter body, the coating comprising:
a manganese oxide catalyst adapted for converting gaseous pollutants into chemically-benign species; and
an adsorbent adapted for adsorbing the chemically-benign species and other gaseous species for which the manganese oxide catalyst is not adapted to convert.

2. The catalyst-adsorbent filter of claim 1, wherein the adsorbent is selected from a group consisting of: silica gel, activated carbon, faujasite, chabazite, clinoptilolite, mordenite, silicalite, zeolite X, zeolite Y, ultrastable zeolite Y, ZSM zeolite, offretite, beta zeolite, metal organic frameworks, metal oxide, polymers, resins, and combinations thereof.

3. The catalyst-adsorbent filter of claim 1, wherein the adsorbent comprises activated carbon.

4. The catalyst-adsorbent filter of claim 3, wherein the activated carbon is synthetic activated carbon or is based on or derived from one or more of wood, peat coal, coconut shell, lignite, petroleum pitch, petroleum coke, coal tar pitch, fruit pits, nuts, shells, sawdust, wood flour, synthetic polymer, or natural polymer.

5. The catalyst-adsorbent filter of claim 1, wherein a Brunauer-Emmett-Teller (BET) surface area of the adsorbent is from about 20 m²/g to about 3,000 m²/g.

6. The catalyst-adsorbent filter of claim 1, wherein a weight-to-weight ratio of the manganese oxide to the adsorbent is from 1:5 to 7:1.

7. The catalyst-adsorbent filter of claim 1, wherein the coating further comprises a polymeric binder, and wherein the polymeric binder is selected from a group consisting of: polyethylene, polypropylene, polyolefin copolymer, polyisoprene, polybutadiene, polybutadiene copolymer, chlorinated rubber, nitrile rubber, polychloroprene, ethylene-propylene-diene elastomer, polystyrene, polyacrylate, polymethacrylate, polyacrylonitrile, poly(vinyl ester), poly(vinyl halide), polyamide, cellulosic polymer, polyimide, acrylic polymer, vinyl acrylic polymer, styrene acrylic polymer, polyvinyl alcohol, thermoplastic polyester, thermosetting polyester, poly(phenylene oxide), poly(phenylene sulfide), fluorinated polymer, poly(tetrafluoroethylene) polyvinylidene fluoride, poly(vinylfluoride) chloro/fluoro copolymer, ethylene chlorotrifluoroethylene copolymer, polyamide, phenolic resin, epoxy resin, polyurethane, acrylic/styrene acrylic copolymer, latex, silicone polymer, and combinations thereof.

8. The catalyst-adsorbent filter of claim 7, wherein the polymeric binder is present from about 5 wt. % to about 30 wt. % with respect to a total weight of the coating.

9. The catalyst-adsorbent filter of claim 1, wherein the coating further comprises a dispersant, and wherein the dispersant comprises one or more of an anionic surfactant, a cationic surfactant, a zwitterionic surfactant, or a nonionic surfactant.

10. The catalyst-adsorbent filter of claim 1, wherein the filter body comprises a polymeric foam comprising polyurethane.

11. The catalyst-adsorbent filter of claim 1, wherein the filter body is in a form of a honeycomb.

12. A catalyst-adsorbent composition comprising:
an adsorbent comprising activated carbon;
a catalyst comprising manganese oxide;
a polymeric binder; and
a surfactant dispersant.

13. A method of forming a catalyst-adsorbent filter, the method comprising:
forming a slurry comprising a metal oxide catalyst and an adsorbent;
coating the slurry onto a filter body comprising a material selected from polymeric foam, polymeric fiber, non-woven fabric, a ceramic, and pulp products; and
drying the slurry to form the catalyst-adsorbent filter.

14. The method of claim 13, wherein the drying occurs at a temperature from about 80° C. to about 250° C.

15. The method of claim 13, wherein the adsorbent comprises activated carbon, and wherein a BET surface area of the adsorbent is from about 20 m²/g to about 3,000 m²/g.

16. The method of claim 13, wherein the metal oxide catalyst comprises manganese oxide, and wherein a weight-to-weight ratio of the manganese oxide to the adsorbent is from 1:5 to 7:1.

17. The method of claim 13, wherein the slurry further comprises a polymeric binder, and wherein the polymeric binder is present from about 5 wt. % to about 30 wt. % with respect to a total weight of the coating, and wherein the polymeric binder is selected from a group consisting of: polyethylene, polypropylene, polyolefin copolymer, polyisoprene, polybutadiene, polybutadiene copolymer, chlorinated rubber, nitrile rubber, polychloroprene, ethylene-propylene-diene elastomer, polystyrene, polyacrylate, polymethacrylate, polyacrylonitrile, poly(vinyl ester), poly(vinyl halide), polyamide, cellulosic polymer, polyimide, acrylic polymer, vinyl acrylic polymer, styrene acrylic polymer, polyvinyl alcohol, thermoplastic polyester, thermosetting polyester, poly(phenylene oxide), poly(phenylene sulfide), fluorinated polymer, poly(tetrafluoroethylene) polyvinylidene fluoride, poly(vinylfluoride) chloro/fluoro copolymer, ethylene chlorotrifluoroethylene copolymer, polyamide, phenolic resin, epoxy resin, polyurethane, acrylic/styrene acrylic copolymer, latex, silicone polymer, and combinations thereof.

18. The method of claim 13, wherein the slurry further comprises a dispersant, and wherein the dispersant comprises one or more of an anionic surfactant, a cationic surfactant, a zwitterionic surfactant, or a nonionic surfactant.

19. The method of claim 13, wherein the filter body comprises a polymeric foam comprising polyurethane.

20. A catalyst-adsorbent filter, the catalyst-adsorbent filter comprising:
a filter body comprising a material selected from polymeric foam, polymeric fiber, non-woven fabric, a ceramic, and pulp products; and
a coating formed on the filter body, the coating comprising:
a manganese oxide catalyst adapted for converting gaseous pollutants into chemically-benign species;
an adsorbent adapted for adsorbing the chemically-benign species together with other gaseous species and volatile organic compounds;
a polymeric binder; and
a dispersant.
